(19) United States
(12) Patent Application Publication
(10) Pub. No.: US 2020/0398722 A1
(43) Pub. Date: Dec. 24, 2020

(54) HEADREST FOR VEHICLE SEAT WITH INTEGRATED SPEAKER

(71) Applicant: FAURECIA Sièges d'Automobile, NANTERRE (FR)

(72) Inventors: Stéphane Soltner, Mailleroncourt Charrette (FR); Benjamin Eller, Paris (FR); Bernd Roehrkaste, Hannover (DE)

(21) Appl. No.: 16/902,627

(22) Filed: Jun. 16, 2020

(30) Foreign Application Priority Data
Jun. 18, 2019 (FR) 1906538

(51) Int. Cl. B60N 2/879

(52) U.S. Cl. CPC B60N 2/879; B60N 2/803

(57) ABSTRACT

A headrest for a vehicle seat comprises at least one speaker partially delimiting a cavity and at least one waveguide having a first end opening into the cavity.

### PRIORITY CLAIM

This application claims priority to French Application No. FR1906538, filed Jun. 18, 2019, which is expressly incorporated by reference herein.

### BACKGROUND

The present disclosure relates to a headrest for a vehicle seat, in particular for a motor vehicle seat. The present disclosure relates more specifically to a headrest for a seat, comprising one or more integrated speakers.

### SUMMARY

According to the present disclosure, a headrest for a vehicle seat is described, comprising at least one speaker partially delimiting a cavity and at least one waveguide having a first end opening into the cavity.

In illustrative embodiments, the speaker can thus excite the air present in the waveguide in a portion of the bandwidth where its efficiency is limited, by making use of the Helmholtz resonator principle.

In illustrative embodiments, the headrest comprises one or more of the following features, alone or in combination:

the headrest comprises a first speaker partially delimiting a first cavity, a first waveguide having a first end opening into the first cavity, a second speaker partially delimiting a second cavity, and a second waveguide having a first end opening into the second cavity;

the opening of the second end of the first waveguide is in the vicinity of the second speaker and the opening of the second end of the second waveguide is in the vicinity of the first speaker;

the waveguides extend in a substantially rectilinear manner in sections, for substantially their entire length;

the first and second waveguides each have a helical section, the helical sections of the first and second waveguides being twisted;

the opening of the second end of the first waveguide is in the vicinity of the first speaker and the opening of the second end of the second waveguide is in the vicinity of the second speaker;

the first waveguide and/or the second waveguide extends/extend in a substantially rectilinear manner in sections, for substantially its/their entire length;

the first waveguide and/or the second waveguide has/have a spiral section;

the headrest comprises at least one housing forming the cavity or cavities, and preferably the waveguide or waveguides;

the headrest comprises a single housing, the single housing having a general “U” shape, a speaker being at the free end of each side arm of the “U”; and

the opening of the first and second waveguides is at the core of the single housing forming the base of the “U”.

In illustrative embodiments, a vehicle seat is described comprising a seating portion, a backrest, and a headrest as described above in all its combinations, mounted on the backrest.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a portion of a motor vehicle seat;

FIG. 2 shows details of a first example of a headrest which can be implemented in the vehicle seat of FIG. 1, some of the trim items of the headrest having been removed;

FIG. 3 is a view of the details of the headrest of FIG. 2, from the opposite perspective;

FIG. 4 is a front view of a first example of a speaker device equipping the headrest of FIGS. 1 to 3;

FIG. 5 is a front view of a second example of a speaker device equipping the headrest of FIGS. 1 to 3;

FIG. 6 is a view, similar to FIG. 3, of another example of a vehicle seat headrest which can be implemented on the vehicle seat of FIG. 1; and

FIG. 7 is a perspective view of an example of a housing of a speaker device which can be implemented in the exemplary headrest of FIG. 6.

### DETAILED DESCRIPTION

In the various figures, the same references designate identical or similar elements. For brevity, only the elements which are useful in understanding the described embodiments are represented in the figures and are described in detail below.

In the description which follows, when reference is made to qualifiers of absolute position such as the terms “front”, “rear”, “top”, “bottom”, “left”, “right”, etc., or relative position such as the terms “above”, “below”, “upper”, “lower”, etc., or to orientation qualifiers such as “horizontal”, “vertical”, etc., unless otherwise specified these are referring the orientation of the figures or of a seat in its normal position of use.

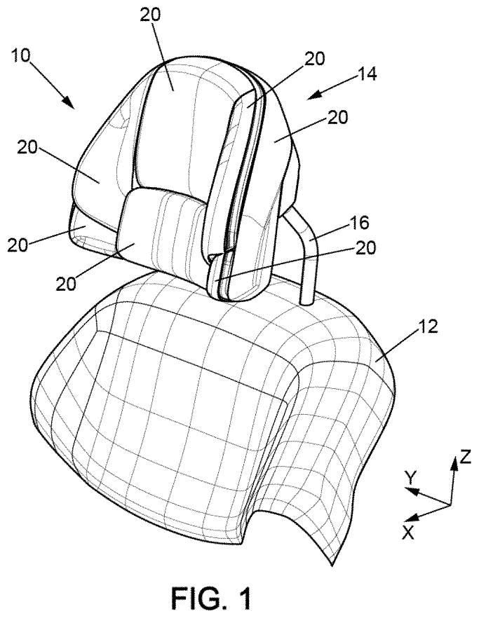

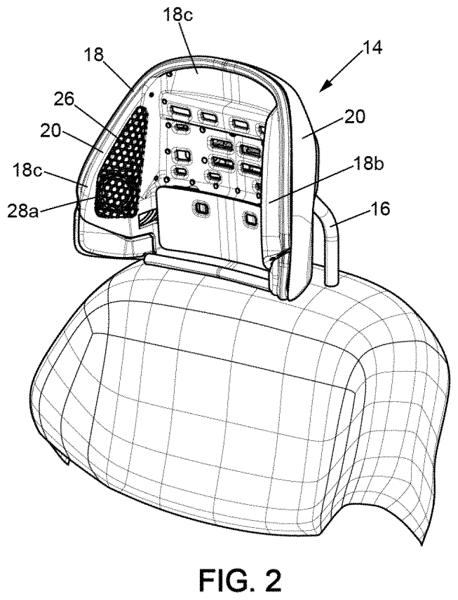

FIG. 1 schematically represents details of a motor vehicle seat 10.

In the following, the longitudinal direction X means the longitudinal direction of the seat. The longitudinal direction of the seat is considered to be the same as the longitudinal direction of the motor vehicle in which the seat is mounted. This longitudinal direction X corresponds to the normal direction of advancement of the vehicle. The transverse direction Y is the transverse direction of the seat. The transverse direction of the seat thus corresponds to the transverse or lateral direction of the motor vehicle. This transverse direction corresponds to a direction perpendicular to the normal direction of advancement of the vehicle. Finally, the vertical direction Z is a vertical direction of the seat, perpendicular to the longitudinal and transverse directions.

The seat 10 comprises a seating portion (not shown) with a seating portion frame, on which is mounted a backrest 12 with a backrest frame, generally pivoting about a transverse axis by a hinge mechanism. The seating portion may be mounted on movable profiles, also called slides or male profiles, by means of feet or crosspieces. Each movable profile is part of a track and is associated with a fixed profile. The fixed profile is fixed to the floor of a motor vehicle.

The seat 10 also comprises a headrest 14 fixed to the backrest frame by means of two rods 16.

More specifically, the rods 16 connect a headrest frame 18 to the backrest frame. On this headrest frame is fixed one or more trim items 20 to improve the comfort of the occupant of the seat 10 and/or the aesthetics of the headrest 14.

The headrest frame 18 here has a bowl shape, presenting a substantially flat base 18c with two side portions 18a, 18b extending from the lateral ends thereof. The headrest frame 18 thus has a shape suitable for partially surrounding the head of the occupant of the seat 10. In particular, the side portions 18a, 18b are thus suitable for being arranged near the ears of the occupant of the seat, being oriented substantially facing the ears of the occupant of the seat 10.

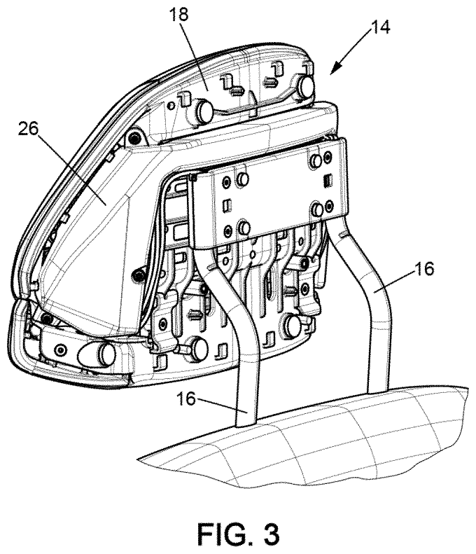

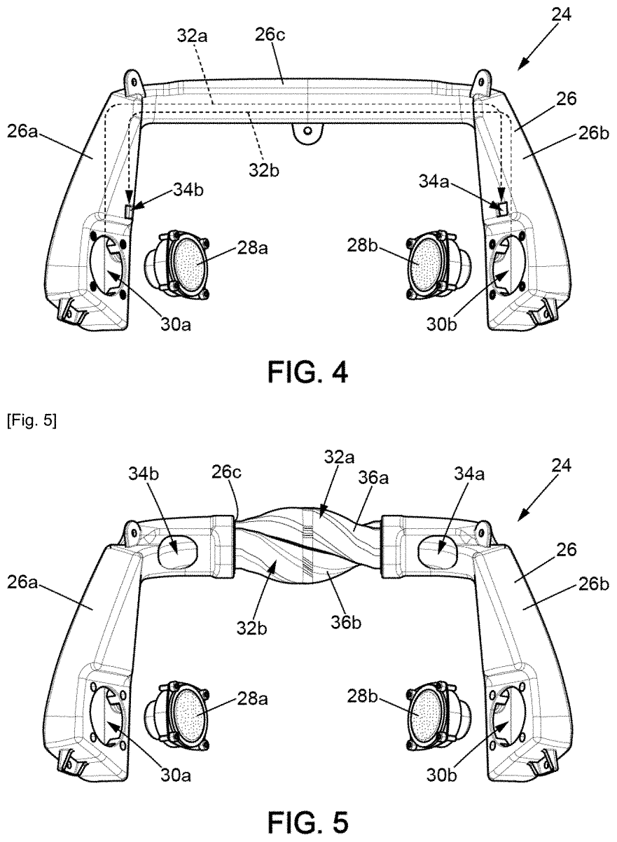

The headrest 14 is also provided with a speaker device 24, more clearly visible in FIGS. 3 and 4. This speaker device 24 essentially comprises a housing 26 in which here are mounted two speakers 28a, 28b.

The speakers 28a, 28b are for example speakers of the full-range type, this type of speaker being able to emit sound in a satisfactory manner in a wide range of frequencies. However, it is known that such speakers, which have a reduced vibrating membrane surface area, are less efficient in low frequencies, in particular in frequencies below 250 Hz, in particular in frequencies between 100 Hz and 250 Hz.

In the current case, the housing 26 has a general “U” shape with a central portion 26c or core of the housing forming the base of the “U”, and two side arms 26a, 26b extending one on either side of the central portion 26c. A speaker 28a, 28b is arranged substantially at the free end of each side arm 26a, 26b of the housing 26.

The housing 26 may be formed as one piece or as a plurality of pieces assembled together. Advantageously, when the housing is formed by an assembly of a plurality of pieces, these are assembled in an airtight manner.

Each speaker 26a, 26b partially defines a cavity 30a, 30b in one of the side arms 26a, 26b of the housing 26. In other words, at least a portion of a wall of each cavity 30a, 30b is formed by a speaker 26a, 26b. Each cavity 30a, 30b is closed, with the exception of an opening towards a passage 32a, 32b (or waveguide) leading to an outlet 34a, 34b. Each passage 32a, 32b is advantageously closed with the exception of its openings at each of its ends. It should be noted here that the outlet 34a, 34b associated with each speaker 28a, 28b is on the opposite side arm 26b, 26a. This increases the length of the passage 32a, 32b. It should be noted here that the passages 32a, 32b here are substantially straight by sections. The cross-section of the passages 32a, 32b is for example round or square. The cross-section of the passages 32a, 32b is in particular substantially constant by sections.

With such a device, it is thus possible to “recover” the backward radiation from each speaker 28a, 28b, directed towards the cavity 30a, 30b, in order to add it in phase with the forward radiation. The passage 32a, 32b and outlet 34a, 34b associated with each cavity 30a, 30b make it possible to implement the Helmholtz resonator principle. Each speaker 28a, 28b can thus excite the volume of air contained in the associated passage 32a, 32b, in a range of frequencies where the speaker 28a, 28b is less efficient. In particular, it is thus possible to emit sound at a higher volume in the low frequencies, in particular in frequencies lower than the cut-off frequency of the speaker 28a, 28b. To do this, it is possible to choose the volume of the cavity 30a, 30b, and the length and the cross-section of the passages 32a, 32b, such that the resonance frequency of the accordingly formed Helmholtz resonator corresponds to a frequency lower than the cut-off frequency of the speaker. In particular, the above dimensions can be chosen to have a resonance frequency of the accordingly formed Helmholtz resonator that is between 100 Hz and 150 Hz, in particular substantially equal to 120 Hz. It is in the vicinity of this resonance frequency that the proposed arrangement presumedly allows emitting a higher volume than a speaker system in a conventional enclosure.

It can be noted here that in order for the two passages 32a, 32b to have the same length, the speaker device 24 is not entirely symmetrical: the outlets 34a, 34b in particular are not symmetrical with respect to a midplane of the device. The same applies to the passages 32a, 32b. However, it is thus possible to create passages 32a, 32b that are straight for a large majority of their length, which presumably gives a better effect to the accordingly formed Helmholtz resonator.

However, it may have a substantially symmetrical configuration of the speaker device 24, for example in order to have the outlets 34a, 34b substantially at the same distance from the ears of an occupant of the seat 10 and thus avoid possible phase differences and/or variations in the volume heard by the seat occupant. To do this, the configuration illustrated in FIG. 5 may be used. In this FIG. 5, the passages 32a, 32b each have a spiral section 36a, 36b, these sections 36a, 36b here also being twisted. It is thus possible to arrange the outlets 34a, 34b symmetrically with respect to a midplane of the speaker device 24, while having passages 32a, 32b of substantially equal length. The cross-sectional area of the passages 32a, 32b may also be equal. It can be noted here that the spiral sections 36a, 36b extend at the base of the “U” of the housing 26 of the speaker device 24. The outlets 34a, 34b may be arranged at the side arms 26a, 26b, as is the case in the example of FIG. 4. However, FIG. 5 illustrates a variant in which the outlets 34a, 34b are located at the base 26c of the “U” formed by the housing 26. However, the outlets 34a, 34b are always arranged in the vicinity of the speaker 28b, 28a opposite the speaker 28a, 28b with which they are respectively associated. In other words, each outlet 34a, 34b is located closer to the speaker 28b, 28a opposite the speaker 28a, 28b with which it is associated, than to this associated speaker 28a, 28b.

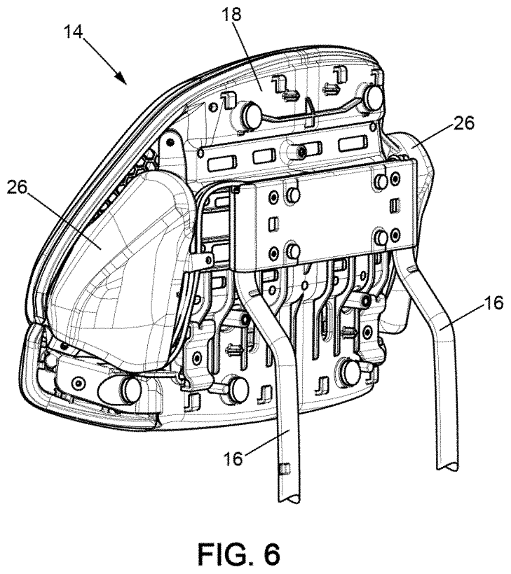

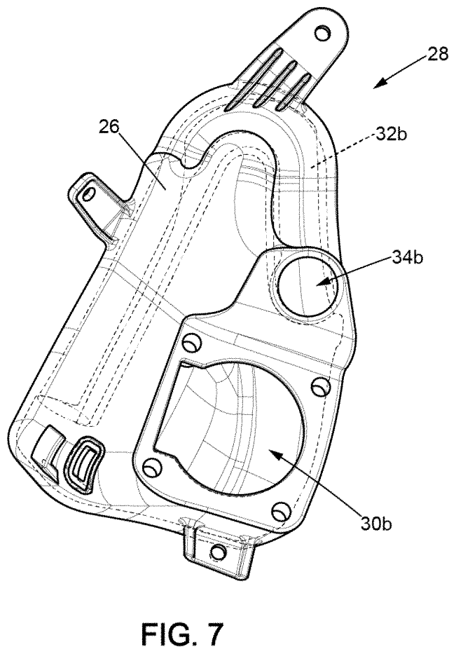

FIGS. 6 and 7 illustrate another example of a speaker device 24. According to these figures, a speaker device 24 comprises two separate housings (only one housing 26 is visible in the figures), each housing 26 being fixed on a respective side portion 18a, 18b of the headrest frame 18. Such an embodiment makes it possible to reduce the space occupied by the device on the headrest.

In this case, each housing 26 has a cavity 30a, 30b, partially defined by a respective speaker 28a, 28b. The cavity 30a, 30b here opens into a passage 32a, 32b formed in the housing 26. Each passage 32a, 32b may be substantially rectilinear in each section. Alternatively, each passage 32a, 32b may extend substantially in a spiraling manner, for at least one section, as shown in FIG. 7. The cross-section of each passage 32a, 32b may be substantially round or square. The cross-section of each passage 32a, 32b may be constant, over at least one section.

In the example of FIG. 7, it is noteworthy that each outlet 34a, 34b is arranged in the vicinity of the speaker 28a, 28b with which it is associated. This reduces the risk of phase differences between the sound emitted by these outlets 34a, 34b and the corresponding sound emitted by the speakers 28a, 28b.

The present disclosure is not limited to the examples described above, but is capable of numerous variants accessible to those skilled in the art.

In particular, in the examples presented, the waveguides 32a, 32b are formed by the housing or housings 26. Alternatively, however, the waveguides 32a, 32b may be formed by tubes, distinct from the housing or housings 26 where appropriate. The tubes forming the waveguides 32a, 32b may, however, be received in the housing or housings 26.

A comparative motor vehicle seat may have a headrest with a speaker integrated into the headrest. This makes it possible to emit a sound as close as possible to the ears of the seat occupant. In particular, this can make it possible to emit a sound so quietly that only the seat occupant hears the sound. Such a speaker may in particular be used to emit sound coming from the radio system of the motor vehicle.

However, the comparative speaker is then placed in a cavity of small dimensions, limited by the desired volume of the headrest. The acoustic qualities of the speaker are thus limited, particularly in the relatively low frequencies.

1. A headrest for a vehicle seat, comprising
at least one speaker partially delimiting a cavity and
at least one waveguide having a first end opening into the cavity.

2. The headrest of claim 1, further comprising a first speaker partially delimiting a first cavity, a first waveguide having a first end opening into the first cavity, a second speaker partially delimiting a second cavity, and a second waveguide having a first end opening into the second cavity.

3. The headrest of claim 2, wherein the opening of the second end of the first waveguide is in the vicinity of the second speaker and the opening of the second end of the second waveguide is in the vicinity of the first speaker.

4. The headrest of claim 3, wherein the waveguides extend in a substantially rectilinear manner in sections, for substantially their entire length.

5. The headrest of claim 3, wherein the first and second waveguides each have a helical section, the helical sections of the first and second waveguides being twisted.

6. The headrest of claim 2, wherein the opening of the second end of the first waveguide is in the vicinity of the first speaker and the opening of the second end of the second waveguide is in the vicinity of the second speaker.

7. The headrest of claim 6, wherein the first waveguide or the second waveguide extends in a substantially rectilinear manner in sections, for substantially its entire length.

8. The headrest of claim 6, wherein the first waveguide and the second waveguide extend in a substantially rectilinear manner in sections, for substantially their entire length.

9. The headrest of claim 6, wherein the first waveguide or the second waveguide has a spiral section.

10. The headrest of claim 6, wherein the first waveguide and the second waveguide have a spiral section.

11. The headrest of claim 1, comprising at least one housing forming the at least one cavity.

12. The headrest of claim 11, wherein the at least one housing further forms the at least one waveguide.

13. The headrest of claim 11, comprising a single housing, the single housing having a general “U” shape, a speaker being at the free end of each side arm of the “U”.

14. The headrest of claim 13, wherein the opening of the first and second waveguides is at the core of the single housing forming the base of the “U”.

15. A vehicle seat comprising a seating portion, a backrest, and the headrest of claim 1, which is mounted on the backrest.
